(19) United States
(12) Patent Application Publication
(10) Pub. No.: US 2004/0174325 A1
(43) Pub. Date: Sep. 9, 2004

(54) Pixel driving circuit of display apparatus

(76) Inventor: Wei-Chieh Hsueh, Tainan (TW)

Correspondence Address: Michael D. Bednarek, Shaw Pittman LLP, 1650 Tysons Boulevard, McLean, VA, 22102, US

(21) Appl. No.: 10/453,528

(22) Filed: Jun. 4, 2003

(30) Foreign Application Priority Data
Mar. 6, 2003 (TW) 92104779

(51) Int. Cl. G09G 3/32

(52) U.S. Cl. 345/82

(57) ABSTRACT

A pixel driving circuit for driving a light-emitting device of a display apparatus is provided. The display apparatus includes a first input terminal and a second input terminal. The pixel driving circuit includes a first switching circuit, a second switching circuit, and a storing circuit. The first switching circuit is connected to the first input terminal and the second input terminal. The second switching circuit is connected to the light-emitting device. The storing circuit is connected to the first switching circuit and the second switching circuit respectively. The first switching circuit, in response to signal states of the first input terminal and the second input terminal, enables the storing circuit to store a voltage that produces a constant current. The second switching circuit controls the constant current flowing through the light-emitting device.

### CROSS REFERENCE TO RELATED APPLICATIONS

This application claims priority of Taiwan Patent Application Serial No. 092104779 filed on Mar. 6, 2003.

### FIELD OF INVENTION

The present invention provides a pixel driving circuit for driving a light-emitting device of a display apparatus.

### BACKGROUND OF THE INVENTION

The display technique changes with each passing day as technology progresses. Succeeding to the light-emitting diode (LED) display technique, a whole new flat panel display technique burgeons. This new technique is referred to as organic light-emitting diode (OLED) display technique.

Generally speaking, a driving circuit is necessary for driving the organic light-emitting diodes. Take active matrix organic light-emitting display (AMOLED) for example, the driving circuit generates a current to drive the organic light-emitting diodes to emit light. The organic light-emitting display may be red, green or blue, or even in full color. Besides, the organic light-emitting display can be rolled up and portable and has no viewing angle problem. Moreover, it has long lifespan and requires low power consumption. Accordingly, it is very possible for the organic light-emitting display to take the place of the conventional light-emitting diodes and become the mainstream of the next generation of display technique.

Each pixel needs one organic light-emitting diode and one driving circuit in an organic light-emitting display. Therefore, there are ten thousands or even millions of driving circuits in a display. That is why the design of these driving circuits becomes a critical issue.

The conventional driving method is stated below. A single driving circuit is enabled through a scan line, and a voltage level is inputted into the driving circuit through a data line. The driving circuit converts the voltage level into a current signal. The current signal drives the organic light-emitting diode to emit light.

An exemplary embodiment of a conventional pixel driving circuit is stated below referring to FIG. 1. First, a control signal is inputted through a scan line 11 to control the on/off state of a first transistor 101. Then a signal is sent through a data line 13 to charge/discharge the capacitor 103, for controlling the on/off state of the second transistor 105. The current flowing through the organic light-emitting diode 107 makes it emit light. However, controlling the voltage across the capacitor 103 may not precisely control the current flowing through the organic light-emitting diode 107, since difference lies between the intrinsic characteristics of first transistor 101 and second transistor 105, e.g. threshold voltage or electron mobility. Because the intensity of light emitted by the organic light-emitting diode 107 may not be precisely controlled, the light-emitting efficiency of the organic light-emitting diodes 107 is not stable. Unstable light-emitting efficiency of the organic light-emitting diode 107 would result in inaccuracy of color display.

To conclude, a pixel driving circuit having precise control over light emitting efficiency is desired to eliminate inaccuracy of color display of the conventional driving circuits.

### SUMMARY OF THE INVENTION

One aspect of the present invention provides a pixel driving circuit for driving a light-emitting device of a display apparatus. The display apparatus includes a first input terminal and a second input terminal. The pixel driving circuit includes a first switching circuit, a second switching circuit, and a storing circuit. The first switching circuit is connected to the first input terminal and the second input terminal. The second switching circuit is connected to the light-emitting device. The storing circuit is connected to the first switching circuit and the second switching circuit respectively. The first switching circuit, in response to signal states of the first input terminal and the second input terminal, enables the storing circuit to store a voltage that produces a constant current. The second switching circuit controls the constant current flowing through the light-emitting device.

The advantages and the spirit of the present invention may be further comprehended through the following descriptions and the accompanying drawings.

### BRIEF DESCRIPTION OF THE DRAWINGS

FIG. 1 is an illustrative diagram showing an exemplary embodiment of a pixel driving circuit according to the prior art;

FIG. 2 is a controlling state diagram of a pixel driving circuit according to the present invention;

FIGS. 3A and 3B are illustrative diagrams showing a first exemplary embodiment of a pixel driving circuit according to the present invention;

FIGS. 4A and 4B are illustrative diagrams showing a second exemplary embodiment of a pixel driving circuit according to the present invention;

FIG. 5 is an illustrative diagram showing a third exemplary embodiment of a pixel driving circuit according to the present invention.

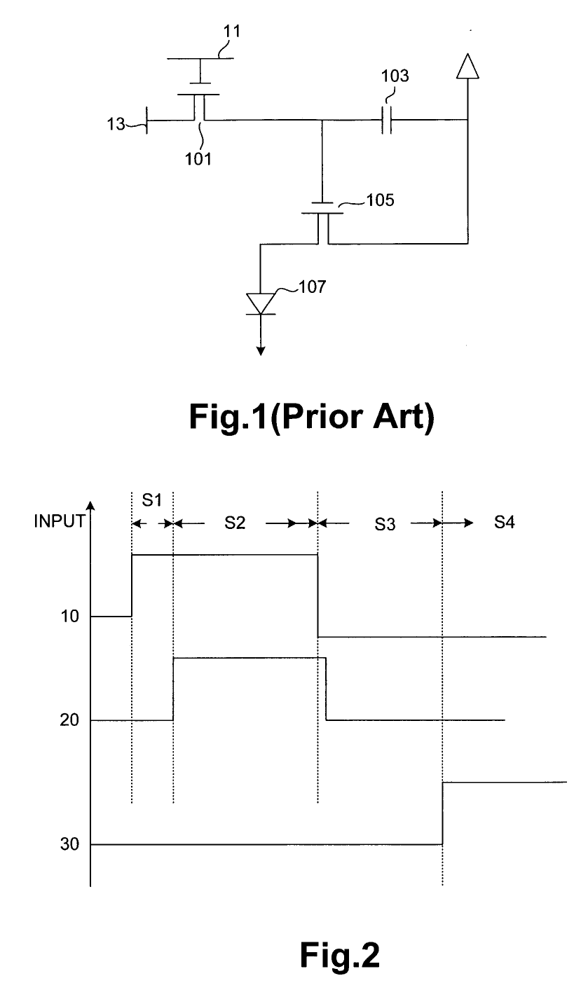

### DETAILED DESCRIPTION

A pixel driving circuit for driving a light-emitting device 40 of a display apparatus is provided. The display apparatus includes a first input terminal 10 and a second input terminal 20. The light-emitting device 40 may be an organic light-emitting diode, which is an exemplary embodiment, but not the limit, of the present invention. Here the first input terminal 10 refers to the scan line through which a high or low voltage is inputted to control a specific pixel. The second input terminal 20 refers to the data line through which a specific current is inputted to control a specific pixel.

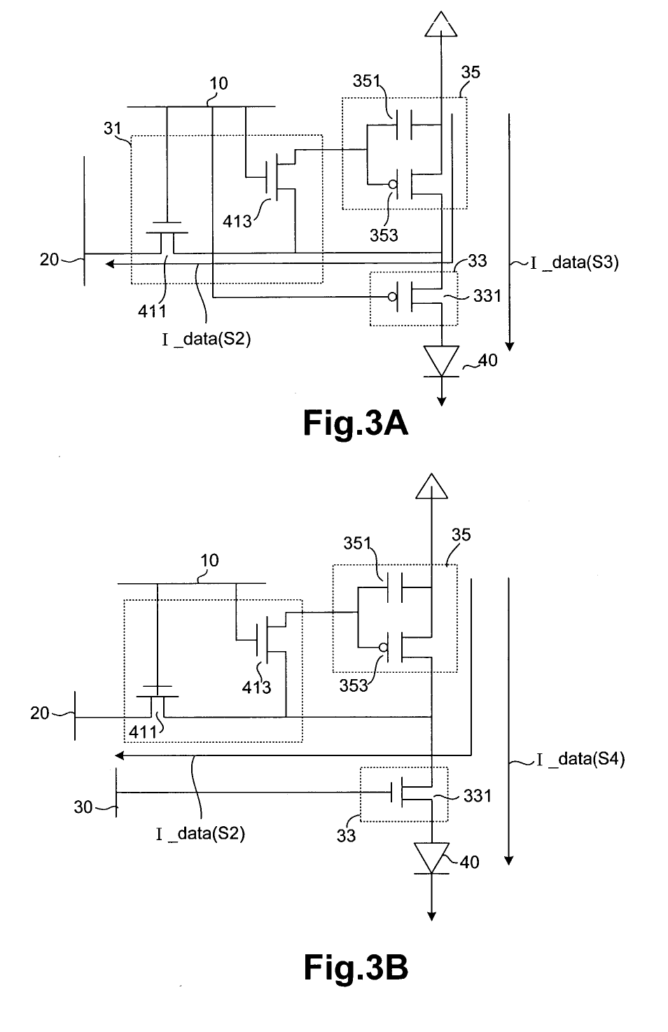

As shown in FIGS. 3A, 3B, 4A, 4B and 5, the pixel driving circuit of the present invention includes a first switching circuit 31, a second switching circuit 33, and a storing circuit 35. The first switching circuit 31 is connected to the first input terminal 10 and the second input terminal 20. The second switching circuit 33 is connected to the light-emitting device 40. Here the second switching circuit 33 includes a fourth transistor 331. A source or a drain of the fourth transistor 331 is connected to the light-emitting device 40 to control the current. The storing circuit 35 is connected to the first switching circuit 31 and the second switching circuit 33 respectively. As shown in the figures, the storing circuit 35 includes a capacitor 351 and a third transistor 353. The capacitor 351 is parallelly connected to the third transistor 353.

To disclose the features of the present invention more clearly and fully, the preferred exemplary embodiments would be stated below sequentially. Please note that the following embodiments are just the way to apply the features of the present invention, but not to limit. Besides, only the difference between the embodiments, but not unnecessary descriptions about what has been disclosed, would be described below.

First Exemplary Embodiment:

FIGS. 3A and 3B are illustrative diagrams showing a first exemplary embodiment of a pixel driving circuit according to the present invention. The first switching circuit 31 includes a first transistor 411 and a second transistor 413. A gate of the first transistor 411 is connected to the first input terminal 10. One of a source and a drain of the first transistor 411 is connected to the second input terminal 20. A gate of the second transistor 413 is connected to the first input terminal 10. A source or a drain of the second transistor 413 is connected to the other one of the source and the drain of the first transistor 411.

As shown in FIG. 3A, the gate of the fourth transistor 331 is connected to the first input terminal 10. To improve the control ability of the circuit, the display apparatus may further include a third input terminal 30. In this case, the gate of the fourth transistor 331 is connected to the third input terminal 30 instead, as shown in FIG. 3B.

To state the features and aspects of the present invention more concisely, the following descriptions would refer to FIG. 3B and FIG. 2. During the period S1, namely the period that a high voltage is inputted into the first input terminal 10, both the first transistor 411 and the second transistor 413 are on. The remaining voltage in the capacitor 351 would be removed.

During the period S2, the high voltage is still inputted into the first input terminal 10, and a driving current I_data is inputted into the second input terminal 20. The driving current I_data may be set in accordance with the user's own need, and the magnitude of I_data is not limited here. Now the first transistor 411 and the second transistor 413 are on, and the third transistor 353 is driven by the driving current I_data. Then the capacitor 351 starts to accumulate and store the voltage V. Here the magnitude of the voltage V has a specific relation with the driving current I_data.

During the period S3, namely the period that a low voltage is inputted into both the first input terminal 10 and the second input terminal 20, the first transistor 411 and the second transistor 413 are off. The capacitor 351 holds the stored voltage V. Now there is yet no current flowing through the light-emitting device 40.

During the period S4, namely the period that the fourth transistor 331 is on, the voltage V stored in the capacitor 351 drives the third transistor 353 to produce a current having the same magnitude as the driving current I_data, as S4 shown in FIG. 3B. This current would flow through the light-emitting device 40 to make it emit. As stated above, with the conversion between the driving voltage V and the driving current I_data, the present invention may prevent the magnitude of the current flowing through the light-emitting device 40 from being affected by any difference between transistors. Accordingly, the present invention may overcome the drawbacks of the conventional driving circuits and precisely control the light-emitting efficiency of the light-emitting device 40.

As shown in FIG. 3A, the gate of the fourth transistor 331 is connected to the first input terminal 10. In this embodiment, the fourth transistor 331 must be of a different type from the first transistor 411 and the second transistor 413. For example, the fourth transistor 331 must be a P-type transistor when the first transistor 411 and the second transistor 413 are N-type transistors. However, the gate of the fourth transistor 331 may be connected to the third input 30 instead to improve the control ability of the circuit, as shown in FIG. 3B. In this case, the type of the first transistor 411, the second transistor 413 and the fourth transistor 331 would not be limited. In other words, the fourth transistor 331 could be a N-type transistor when the first transistor 411 and the second transistor 413 are N-type transistors.

In a word, for FIG. 3B, the period S4 shown in FIG. 2 is the period that a high voltage is inputted into the third input terminal 30 to enable the fourth transistor 331. For FIG. 3A, on the other hand, the period that the fourth transistor 331 is enabled should be the period S3.

Besides, the present invention could modify the time-span of emission of the light-emitting device 40 by controlling the time-span of enabling of the third input terminal 30. Then the present invention could further control the light-emitting time-span of different colors to stabilize the light-emitting efficiency of different colors and eliminate non-uniformity of the color display intensity.

Second Exemplary Embodiment:

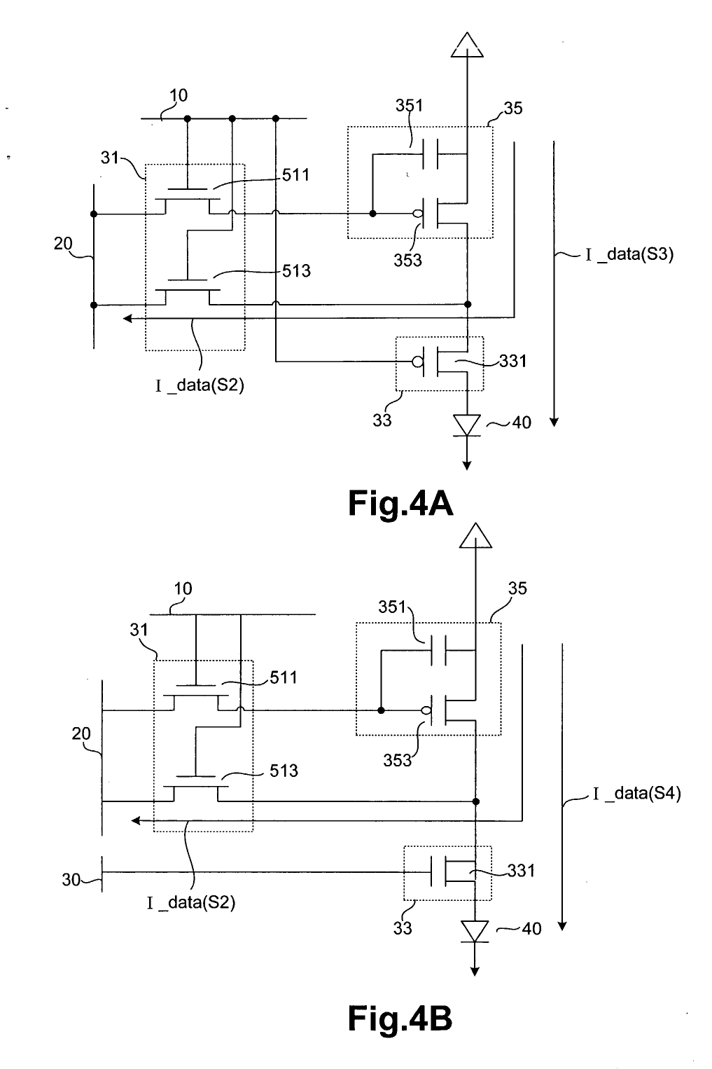

FIGS. 4A and 4B show a second exemplary embodiment of the present invention. The first switching circuit 31 of the second exemplary embodiment includes a first transistor 511 and a second transistor 513. The operation of the driving circuit of the second exemplary embodiment is the same way as in the first exemplary embodiment, and is not repeatedly described herein. The only difference from the first exemplary embodiment lies in that the first transistor 511 and the second transistor 513 of the second embodiment are parallelly connected, while the first transistor 411 and the second transistor 413 of the first embodiment are serially connected.

As shown in FIGS. 4A and 4B, the gate of the first transistor 511 is connected to the first input terminal 10. The source or drain of the first transistor 511 is connected to the second input terminal 20. The gate of the second transistor 513 is connected to the first input terminal 10. The source or drain of the second transistor 513 is connected to the second input terminal 20.

Third Exemplary Embodiment:

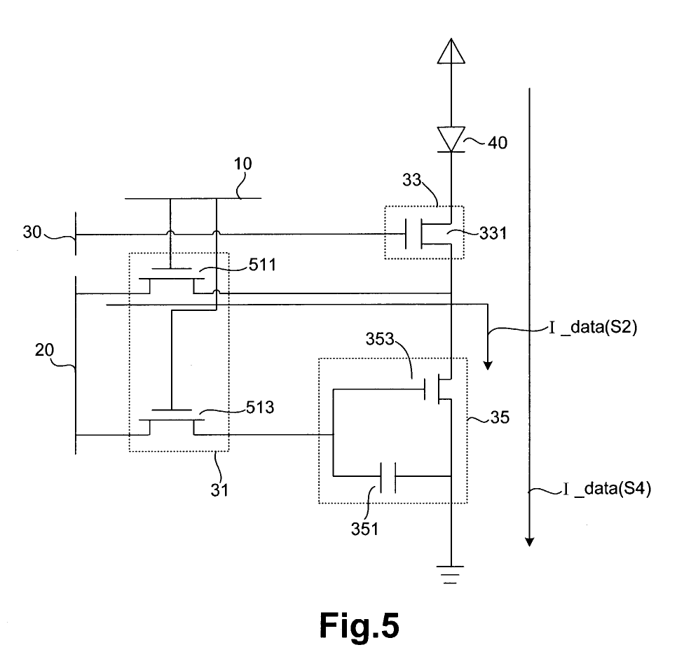

FIG. 5 shows a third exemplary embodiment of the present invention. By comparing FIG. 4B and FIG. 5, the difference between the third and the second embodiments is known to be the arrangement of the second switching circuit 33 and the storing circuit 35. However, this modification is just another embodiment and does not depart from the features of the present invention, and so is not unnecessarily detailed herein.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A pixel driving circuit for driving a light-emitting device of a display apparatus, said display apparatus including a first input terminal and a second input terminal, said pixel driving circuit comprising:
a first switching circuit connected to said first input terminal and said second input terminal;
a second switching circuit connected to said light-emitting device; and
a storing circuit respectively connected to said first switching circuit and said second switching circuit;
wherein said first switching circuit, responsive to signal states respectively at said first input terminal and said second input terminal, enables said storing circuit to store a voltage producing a constant current, said second switching circuit controls said constant current flowing through said light-emitting device.

2. The pixel driving circuit of claim 1, wherein said first switching circuit further comprises:
a first transistor, a gate of said first transistor being connected to said first input terminal, one of a source and a drain of said first transistor being connected to said second input terminal; and
a second transistor, a gate of said second transistor being connected to said first input terminal, a source or a drain of said second transistor being connected to the other one of said source and said drain of said first transistor.

3. The pixel driving circuit of claim 1, wherein said first switching circuit further comprises:
a first transistor, a gate of said first transistor being connected to said first input terminal, a source or a drain of said first transistor being connected to said second input terminal; and
a second transistor, a gate of said second transistor being connected to said first input terminal, a source or a drain of said second transistor being connected to said second input terminal.

4. The pixel driving circuit of claim 1, wherein said storing circuit further comprises:
a capacitor; and
a third transistor;
wherein said capacitor is parallelly connected to said third transistor.

5. The pixel driving circuit of claim 1, wherein said second switching circuit further comprises:
a fourth transistor, a source or a drain of said fourth transistor being connected to said light-emitting device to control said constant current.

6. The pixel driving circuit of claim 5, wherein a gate of said fourth transistor is connected to said first input terminal.

7. The pixel driving circuit of claim 5, wherein said display apparatus further comprises a third input terminal, a gate of said fourth transistor is connected to said third input terminal.

8. A pixel driving circuit for driving a light-emitting device of a display apparatus, said display apparatus including a first input terminal and a second input terminal, said pixel driving circuit comprising:
a first transistor;
a second transistor, both gates of said first transistor and of said second transistor being connected to said first input terminal;
a fourth transistor connected to said light-emitting device;
a capacitor;
a third transistor, said capacitor being parallelly connected to said third transistor, said capacitor and said third transistor being respectively connected to said first transistor, said second transistor and said fourth transistor;
wherein said first transistor and said second transistor, responsive to signal states respectively at said first input terminal and said second input terminal, enables said capacitor to store a voltage producing a constant current, said fourth transistor controls said constant current flowing through said light-emitting device.

9. The pixel driving circuit of claim 8, wherein one of a source and a drain of said first transistor is connected to said second input terminal, a source or a drain of said second transistor is connected to the other one of said source and said drain of said first transistor.

10. The pixel driving circuit of claim 8, wherein a source or a drain of said first transistor is connected to said second input terminal, and a source or a drain of said second transistor is connected to said second input terminal.

11. The pixel driving circuit of claim 8, wherein a gate of said fourth transistor is connected to said first input terminal.

12. The pixel driving circuit of claim 8, wherein said display apparatus further comprises a third input terminal, a gate of said fourth transistor is connected to said third input terminal.

13. A display apparatus for displaying at least one pixel, corresponding to each said pixel, said display apparatus comprising:
a light-emitting device;
a first input terminal;
a second input terminal; and
a pixel driving circuit, comprising:
a first switching circuit connected to said first input terminal and said second input terminal;
a second switching circuit connected to said light-emitting device; and
a storing circuit respectively connected to said first switching circuit and said second switching circuit;
wherein said first switching circuit, responsive to signal states respectively at said first input terminal and said second input terminal, enables said storing circuit to store a voltage producing a constant current, said second switching circuit controls said constant current flowing through said light-emitting device.

14. The display apparatus of claim 13, wherein said first switching circuit further comprises:
a first transistor, a gate of said first transistor being connected to said first input terminal, one of a source and a drain of said first transistor being connected to said second input terminal; and
a second transistor, a gate of said second transistor being connected to said first input terminal, a source or a drain of said second transistor being connected to the other one of said source and said drain of said first transistor.

15. The display apparatus of claim 13, wherein said first switching circuit further comprises:
a first transistor, a gate of said first transistor being connected to said first input terminal, a source or a drain of said first transistor being connected to said second input terminal; and
a second transistor, a gate of said second transistor being connected to said first input terminal, a source or a drain of said second transistor being connected to said second input terminal.

16. The display apparatus of claim 13, wherein said storing circuit further comprises:
a capacitor; and
a third transistor;
wherein said capacitor is parallelly connected to said third transistor.

17. The display apparatus of claim 13, wherein said second switching circuit further comprises:
a fourth transistor, a source or a drain of said fourth transistor being connected to said light-emitting device to control said constant current.

18. The display apparatus of claim 17, wherein a gate of said fourth transistor is connected to said first input terminal.

19. The display apparatus of claim 17, wherein said display apparatus further comprises a third input terminal, a gate of said fourth transistor is connected to said third input terminal.
